(19) United States
(12) Patent Application Publication
(10) Pub. No.: US 2018/0314979 A1
(43) Pub. Date: Nov. 1, 2018

(54) SYSTEMS AND METHODS FOR PROCESSING RADIO DATA SYSTEM FEEDS

(71) Applicant: GM GLOBAL TECHNOLOGY OPERATIONS LLC, Detroit, MI (US)

(72) Inventors: GAURAV TALWAR, NOVI, MI (US); XU FANG ZHAO, LASALLE (CA)

(73) Assignee: GM GLOBAL TECHNOLOGY OPERATIONS LLC, Detroit, MI (US)

(21) Appl. No.: 15/581,878

(22) Filed: Apr. 28, 2017

(51) Int. Cl. G06N 99/00; H04W 4/20; H04W 4/04; G10L 15/26; G10L 15/18; G06Q 30/02

(52) U.S. Cl. CPC G06N 99/005; H04W 4/20; G06Q 30/0241; G10L 15/265; G10L 15/18; H04W 4/046

(57) ABSTRACT

Methods and systems are provided for radio data system (RDS) feed data in a vehicle. In one embodiment, a method includes: receiving, by a processor, RDS feed data; processing, by a processor, the RDS feed data to determine a classification of the RDS feed data to be at least one of active programming and advertisement; and storing, by a processor, information extracted from the RDS feed data based on the classification.

### TECHNICAL FIELD

The technical field generally relates to data processing, and more particularly relates to methods and systems for processing radio data system feeds in systems of a vehicle.

### BACKGROUND

Radio Data System (RDS) is a communications protocol standard for embedding small amounts of digital information in a conventional FM radio broadcast. An RDS feed includes information such as, time, station identification, program information, and advertisement information. In some instance, some of the data from the RDS feed is displayed to the user by an infotainment system.

It is desirable to provide methods and systems for processing the RDS feed and making use of the data in the RDS feed in other vehicle applications. Furthermore, other desirable features and characteristics of the present invention will become apparent from the subsequent detailed description and the appended claims, taken in conjunction with the accompanying drawings and the foregoing technical field and background.

### SUMMARY

Accordingly, methods and systems are provided for radio data system (RDS) feed data in a vehicle. In one embodiment, a method includes: receiving, by a processor, RDS feed data; processing, by a processor, the RDS feed data to determine a classification of the RDS feed data to be at least one of active programming and advertisement; and storing, by a processor, information extracted from the RDS feed data based on the classification.

In one embodiment, a system includes a first non-transitory module that receives, by a processor, the RDS feed data. The system further includes a second non-transitory module that processes, by the processor, the RDS feed data to determine a classification of the RDS feed data to be at least one of active programming and advertisement, and that stores, by the processor, information extracted from the RDS feed data based on the classification.

In one embodiment, a vehicle includes an infotainment system that receives radio data system (RDS) feed data. The vehicle further includes a speech system that processes audio data of the RDS feed data to extract information. The vehicle further includes a RDS data processing module that processes the RDS feed data and the extracted information to determine a classification of the RDS feed data to be at least one of active programming and advertisement, and that when the classification is determined to be advertisement, further processes the RDS feed data and the extracted information to determine a sub-classification of the advertisement, and store the extracted information and the sub-classification as a data object in a data storage device.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a radio data system feed processing system in accordance with various exemplary embodiments;

FIG. 2 is a dataflow diagram illustrating the radio data system feed processing module in more detail in accordance with various exemplary embodiments; and

FIG. 3 is a flowchart illustrating a method that may be performed by radio data system feed processing system in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality. As can be appreciated, the modules described herein can be combined and/or partitioned into additional modules in various embodiments.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of steering control systems, and that the vehicle system described herein is merely one example embodiment of the invention.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

In accordance with exemplary embodiments of the present disclosure a radio data system (RDS) feed processing system 10 is shown to be included within a vehicle 12. The RDS feed processing system 10 processes RDS data along with associated audio data and selectively archives the data for later access. For example, many times a user of the vehicle 12 encounters an interesting advertisement while listening to live radio. For example, there is a promotion going on by a local car dealership that shall expire soon. The promotion may include a phone number and other important details. Since the user is driving, the user does not have any access to this information offline. The RDS feed processing system 10 processes the RDS data along with the audio data to extract useful information in this scenario and archive the useful information for later use.

In various embodiments, the RDS feed processing system 10 receives the RDS data and the other audio data from an infotainment system 13 of the vehicle 12. The infotainment system 13 includes, at a minimum, an antenna and a radio that receives the broadcasted data from the various radio stations and plays the data in the vehicle 12. As can be appreciated, the infotainment system 13 can include other systems, such as, but not limited to, navigation systems, media systems, telematics systems, phone systems, and internet or network systems.

In various embodiments, the RDS feed processing system 10 processes the other audio data using a speech system 15 of the vehicle 12. For example, the speech system 15 provides speech recognition or understanding and a dialog for one or more vehicle systems through a human machine interface (HMI) module 14. Such vehicle systems may include the systems of the infotainment system 13 or any other vehicle system that may include a speech dependent application. As can be appreciated, one or more embodiments of the speech system 15 can be applicable to other non-vehicle systems having speech dependent applications and thus, is not limited to the present vehicle example. In various embodiments, the HMI module 14 includes, at a minimum, a recording device for recording speech utterances of a user or the played audio data and an audio and/or visual device for presenting a dialog or any other multimodal interaction to the user. The speech system 15 and/or the HMI module 14 communicate with the infotainment system 13 through a communication bus and/or other communication means 20 (e.g., wired, short range wireless, or long range wireless). The communication bus can be, for example, but is not limited to, a controller area network (CAN) bus, local interconnect network (LIN) bus, or any other type of bus.

In various embodiments, the speech system 15 includes a speech recognition module 32 and a dialog manager module 34. As can be appreciated, the speech recognition module 32 and the dialog manager module 34 may be implemented as separate speech systems and/or as a combined speech system 15 as shown. In general, the speech recognition module 32 receives and processes the speech utterances from the HMI module 14 using one or more speech recognition or understanding techniques that rely on one or more language models. The speech recognition module 32 generates one or more possible results from the speech utterance (e.g., based on a confidence threshold) and provides the possible results to the dialog manager module 34 and/or the HMI module 14.

The dialog manager module 34 manages a dialog based on the results. In various embodiments, the dialog manager module 34 determines the next dialog prompt 30 to be generated by the speech system 15 in response to the results. The next dialog prompt 30 is provided to the HMI module 14 to be presented to the user.

In various embodiments, the infotainment system 13 plays the audio data and the infotainment system 13 records the played audio. The speech system 15, in turn, processes the recorded audio and provides the recognized results to the RDS feed processing system 10 via the HMI module 14.

In various exemplary embodiments, the speech system 15 performs the speech processing and/or the dialog management based on the archived RDS data. For example, the RDS data processing system 10 provides updated language models to the speech system 15. The language models are updated by the RDS data processing system 10 based on the RDS data and the recognized results of the audio data. The speech system 15 uses the speech models in speech processing and dialog management.

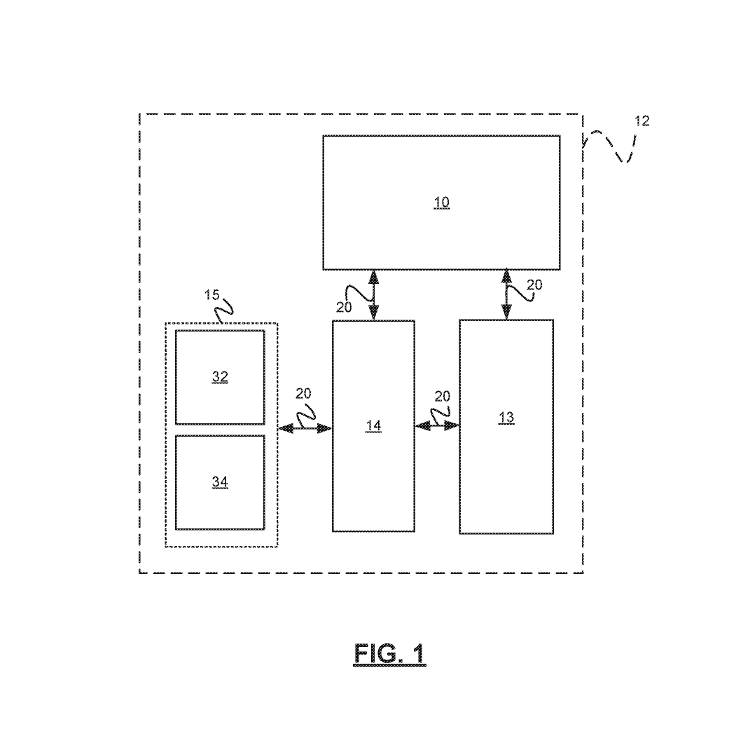

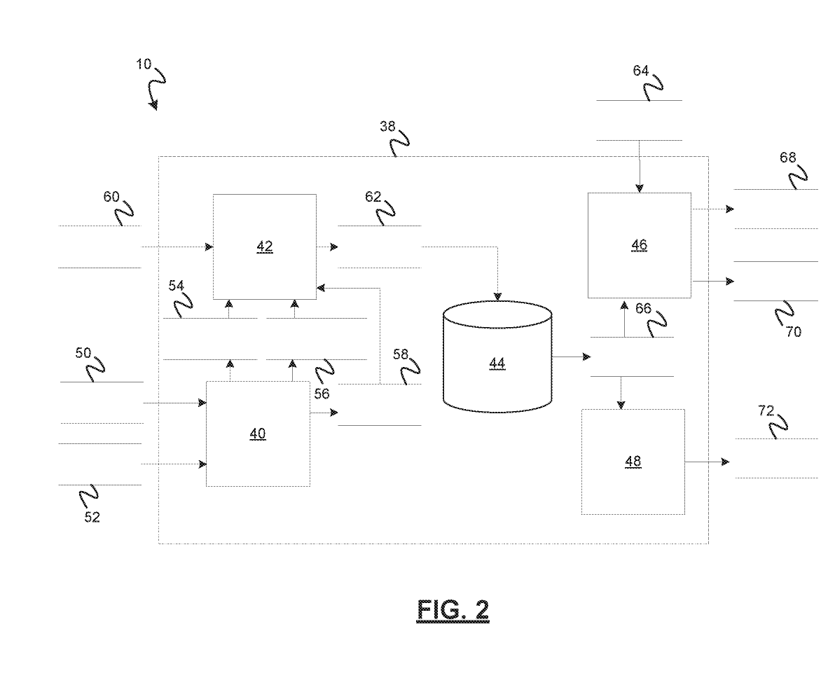

Referring now to FIG. 2 and with continued reference to FIG. 1, a dataflow diagram illustrates a RDS feed processing module 38 of the RDS feed processing system 10 in accordance with various exemplary embodiments. As can be appreciated, various exemplary embodiments of the RDS data processing module 38, according to the present disclosure, may include any number of sub-modules. In various exemplary embodiments, the sub-modules shown in FIG. 2 may be combined and/or further partitioned to similarly process the RDS data along with other audio data. In various embodiments, the RDS data processing module includes an audio data processing module 40, an RDS data processing module 42, an archive data datastore 44, a data request manager module 46, and a language model update module 48.

The audio data processing module 40 receives audio data 50 and recognized speech 52 from the audio data 50, for example, from the speech system 15. The audio data processing module 40 processes the recognized speech 52 using one or more machine learning techniques (e.g., neural networks, recursive neural networks, support vector machine, K nearest neighbor, cluster analysis, dimensionality reduction methods, linear regression, logistic regression, decision trees, Bayesian probabilities, random forest, gradient boost and ada-boost, etc.) to classify the audio data as active programming or advertisement and generate classification data 54 based thereon. For example, certain key words, or combinations of key words can be used to identify the audio data as being an advertisement.

In addition, the audio data processing module 40 processes the recognized speech 52 using one or more machine learning techniques (e.g., neural networks, recursive neural networks, support vector machine, K-nearest neighbor, cluster analysis, dimensionality reduction methods, linear regression, logistics regression, decision trees, Bayesian probabilities, random forest, gradient boost, ada-boost, etc.) to sub-classify the advertisement into one or more sub-classifications and generate sub-classification data 56 based thereon. The sub-classifications can include, for example, but are not limited to, home improvements, car dealerships, interior decor, travel services, landscaping, healthcare, entertainment, etc. For example, certain key words, or combinations of key words can be used to sub-classify the audio data.

The RDS data processing module 42 receives RDS data 60 (corresponding to the audio data 50), for example, from the infotainment system 13 (FIG. 1), and the classification data 54 and the sub-classification data 56, from for example, the audio data processing module 40. The RDS data processing module 42 processes the RDS data 60 to extract certain information, and constructs a data object 62 based on the extracted information. In various embodiments, the RDS data processing module 42 extracts the information based on whether the data is classified as active programming or advertisement. When the classification data 54 indicates active programming, the RDS data 60 is not processed. However, when the classification data 54 indicates advertisement, the RDS data 60 is processed and information such as primary information about the business. Such as Business name, e.g., GM Dealership, Type of Service: Vehicle Sales and Service, Phone/Web Page/Open Hours/Address/Customer Reviews. Thereafter, the data RDS data processing module 42 constructs the data object 62 from the classification data 54, the sub-classification data 56, and the extracted data.

In various embodiments, the data object 62 can be an XML, JSON, or other object type. For example, given the scenario discussed above about the promotion going on by a local car dealership, an exemplary JSON data object can include:

```
JSON Object
{
    ″msg_id″ : ″6a84eae3-969c-41ad-94d9-85076fbbdc99″,
    ″msg body″ : ″Suburban Buick and GMC″,
    ″outcome″ : {
    ″intent″ : ″Car Dealership Classified″,
    ″entities″ : {
      ″object″ : {
        ″value″ : ″1-800-222-7898″,
        ″body″ : ″www.Suburban.Buick/Promotion2015″
      }
    },
    ″confidence″ : 0.997
  }
}
```

The RDS data processing module 42 stores the data objects 62 in the archive data datastore 44 for future processing. The data objects 62 may be stored for a certain time period, based on a capacity of the storage (e.g., if full based on a last in first out method, or other method), or based on other methods of archiving.

The data request manager module 46 receives a request 64 for advertisement information. In various embodiments, the request 64 may be based on a user's interaction with the HMI module 14 (FIG. 1) and the speech system 15 (FIG. 1). For example, the user may issue (e.g., speak or by another interaction with an input device) a request to retrieve commercials, and the speech system 15 carries out a dialog (e.g., spoken or through a user interface) with the user in order to determine a requested sub-classification of the commercial. The data request manager module 46 receives the request 64 and retrieves from the archive data datastore 44 the corresponding data object 66 and presents the information from the data object 66 to the user.

In various embodiments, the data request manager module 46 generates information data 68 that is communicated to the infotainment system 13 which presents the information to the user. In various embodiments, the data request manager module 46 generates information signals 70 that are communicated to a personal device of the user for presenting the information to the user or storing for future use (e.g., in an address book, calendar, navigation system, etc.).

The language model update module 48 retrieves from the archive data datastore 44 the stored data objects 66. Based on the sub-classifications of the retrieved data objects 66, the language model update module 48 generates an updated language model 72. The updated language model 72 is communicated to the speech system 15 for use in speech recognition and/or dialog management.

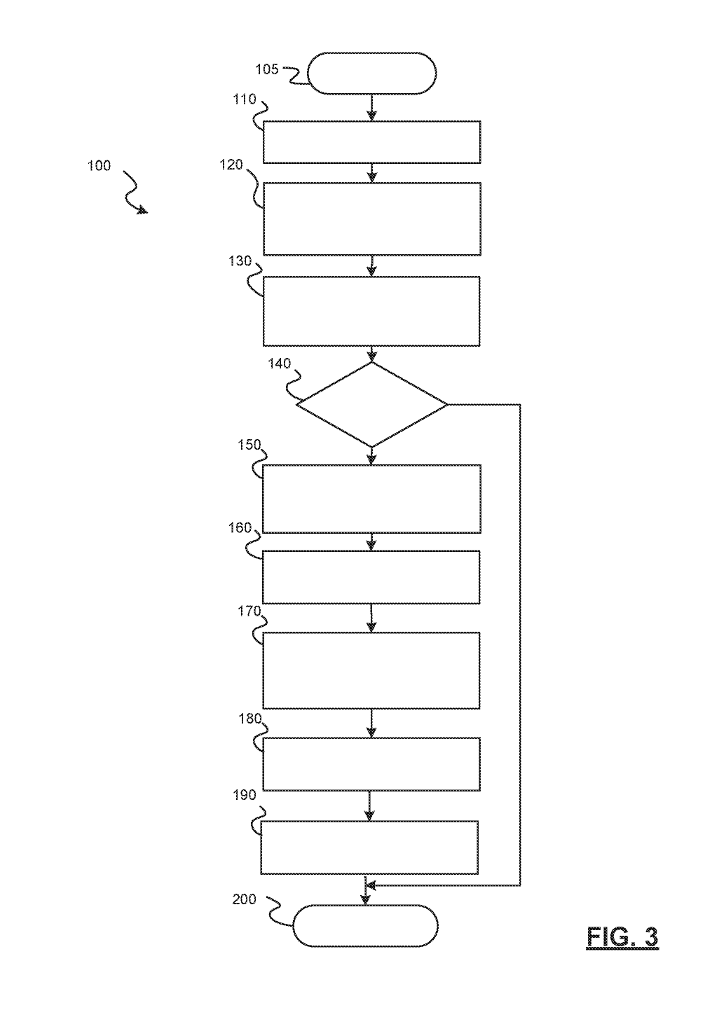

Referring now to FIG. 3 and with continued reference to FIG. 2, a flowchart illustrates a method 100 that may be performed by the RDS feed processing system 10 in accordance with various exemplary embodiments. As can be appreciated in light of the disclosure, the order of operation within the method 100 is not limited to the sequential execution as illustrated in FIG. 3, but may be performed in one or more varying orders as applicable and in accordance with the present disclosure. As can further be appreciated, one or more steps of the method 100 may be added or removed without altering the spirit of the method 100.

As shown, the method 100 may begin at 105. The RDS data 60 and the audio data 50 are received at 110. The audio data 50 is processed by the speech system 15 (FIG. 1) at 120 to extract key words, phrases, and/or audio clips. Machine learning is performed on the extracted data to classify the audio data as an advertisement or active programming at 130. In various embodiments, the audio stream through the radio broadcast can be tagged persistently as programming, and advertisement. In such case, the tagged type can be relied upon.

Thereafter, at 140, the classification is evaluated. If the classification is active programming, the audio data 50 and the RDS data 60 are not further processed and the method may end at 190. If, however, the classification is advertisement at 140, additional machine learning techniques are performed on the extracted information to sub-classify the advertisement at 155 for example as discussed above. In various embodiments, the additional classification may be used to identify the business service/commodity per the user preferences. For example, if the user is interested in real estate, landscaping and fitness & health related classifieds. Any classified with that match shall be archived for later use to the user.

The RDS data 60 is processed at 160 to extract information, for example, as discussed above. A data object 62 is created based on the sub-classification, the extracted information from the audio data 50, and the extracted information from the RDS data 60 at 170. Thereafter, the data object 62 is archived for future use at 180. For example, the data object 62 is archived for a predefined time, or based on a storage capacity. Thereafter, the archived data objects 66 can be processed at 180 based on data requests 64 as discussed above and/or to produce updated language models 72 as discussed above, For example, all of the information can be used to prepare a glossary of words, phrases to train the language models or statistical language models. These models are instrumental in enabling natural language understanding such that the user can request information in natural language open ended fashion rather than saying the stipulated commands. Therefore, new language models or updating of existing models can be performed based on the information. Thereafter, the method may end at 190.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for processing radio data system (RDS) feed data in a vehicle, comprising:
receiving, by a processor, RDS feed data;
processing, by a processor, the RDS feed data to determine a classification of the RDS feed data to be at least one of active programming and advertisement; and
storing, by a processor, information extracted from the RDS feed data based on the classification.

2. The method of claim 1, wherein the RDS feed data includes audio data, and wherein the processing comprises processing the audio data with a speech system to extract information for determining the classification.

3. The method of claim 1, further comprising processing, by a processor, the RDS feed data to determine a sub-classification of the RDS feed data, and wherein the storing the information is further based on the sub-classification.

4. The method of claim 3, wherein the sub-classification is at least one of home improvements, car dealerships, interior decor, travel services, landscaping, healthcare, and entertainment.

5. The method of claim 3, further comprising updating a language model based on the sub-classification.

6. The method of claim 3, wherein the processing the RDS feed data to determine the sub-classification is based on a machine learning method.

7. The method of claim 1, wherein the processing the RDS feed data to determine a classification is based on at least one machine learning method.

8. The method of claim 1, further comprising processing, by a processor, a request for archived data from a user; and retrieving the stored information based on the request.

9. The method of claim 1, wherein the storing comprises storing the information as a data object.

10. A system for processing RDS feed data in a vehicle, comprising:
a first non-transitory module that receives, by a processor, the RDS feed data; and
a second non-transitory module that processes, by the processor, the RDS feed data to determine a classification of the RDS feed data to be at least one of active programming and advertisement, and that stores, by the processor, information extracted from the RDS feed data based on the classification.

11. The system of claim 10, wherein the RDS feed data includes audio data, and wherein the processing comprises processing the audio data with a speech system to extract information for determining the classification.

12. The system of claim 10, further comprising processing, by a processor, the RDS feed data to determine a sub-classification of the RDS feed data, and wherein the storing the information is further based on the sub-classification.

13. The system of claim 12, wherein the sub-classification is at least one of home improvements, car dealerships, interior decor, travel services, landscaping, healthcare, and entertainment.

14. The system of claim 12, further comprising updating a language model based on the sub-classification.

15. The system of claim 12, wherein the processing the RDS feed data to determine the sub-classification is based on a machine learning method.

16. The system of claim 10, wherein the processing the RDS feed data to determine a classification is based on at least one machine learning method.

17. The system of claim 10, further comprising processing, by a processor, a request for archived data from a user; and retrieving the stored information based on the request.

18. The system of claim 10, wherein the storing comprises storing the information as a data object.

19. A vehicle, comprising:
an infotainment system that receives radio data system (RDS) feed data;
a speech system that processes audio data of the RDS feed data to extract information; and
a RDS data processing module that processes the RDS feed data and the extracted information to determine a classification of the RDS feed data to be at least one of active programming and advertisement, and that when the classification is determined to be advertisement, further processes the RDS feed data and the extracted information to determine a sub-classification of the advertisement, and store the extracted information and the sub-classification as a data object in a data storage device.
